(19) United States
(12) Patent Application Publication
(10) Pub. No.: US 2018/0241143 A1
(43) Pub. Date: Aug. 23, 2018

(54) M-LIKE ELASTIC CONTACT SPRING AND TERMINATED ADAPTOR CONNECTOR

(71) Applicant: AVIC JONHON OPTRONIC TECHNOLOGY CO., LTD, Luoyang, Henan (CN)

(72) Inventors: Guoqi ZHOU, Luoyang, Henan (CN); Lei ZHANG, Luoyang, Henan (CN); Xiaoguang ZHANG, Luoyang, Henan (CN)

(73) Assignee: AVIC JONHON OPTRONIC TECHNOLOGY CO., LTD, Luoyang, Henan (CN)

(21) Appl. No.: 15/531,603

(22) PCT Filed: Nov. 25, 2015
(86) PCT No.: PCT/CN2015/095502

§ 371 Date: May 30, 2017

(30) Foreign Application Priority Data
Nov. 28, 2014 (CN) 201410701430.6
Nov. 28, 2014 (CN) 201410701618.0

(51) Int. Cl. H01R 13/24; H01R 31/06

(52) U.S. Cl. CPC H01R 13/2428; H01R 31/06

(57) ABSTRACT

Disclosed are an M-like elastic contact spring and a terminated adaptor connector. The M-like elastic contact spring comprises two contact portions at two ends and a connecting portion connected between the two contact portions, the contact portions are arc-shaped, the connecting portion is U-shaped, the contact portions are in arc transitional connection with the connecting portion, and the connecting portion and the contact portions form an M structure together. When the contact portions are in contact with the adaptor connector and stressed during usage, the M-like elastic contact spring at least has the following deformable parts: a bent part of the U-shaped connecting portion, transitional parts of the contact portions and the connecting portion, and the parts, close to the connecting portion, of the contact portions; thus, the bending stress of the contact spring under stress can be greatly dispersed, and the fatigue of the contact spring is relieved, and the problem that the contact spring is easily damaged by fatigue is solved.

### FIELD OF THE INVENTION

The present invention relates to the field of electrical connectors, and particularly, to an M-like elastic contact spring and terminated adaptor connector.

### BACKGROUND OF THE INVENTION

Electrical connectors are common components for electrical signal transmission, and are widely applied not only in the industries of communication, power transmission and the like but also in the fields of aerospace and the like nowadays. In some special occasions, contacts of the electrical connectors transmit electrical signals in an elastic pressure contact manner instead of a conventional plug-in manner, such electrical connectors are always used for switching electrical signals and each includes a panel, the panel is provided with a penetrating mounting hole, an elastic contact is arranged in the mounting hole, two ends of the contact respectively form contact portions, and the contact portions are in elastic contact with a conductive plate or similar component of an adaptor connector during usage to switch electrical signals.

Among said electrical connectors for switching signals, there are mainly three common types of contacts as follows: 1, C-shaped: 2, V-shaped; and 3, spiral. The structure of the C-shaped contact is shown in FIG. 1, the C-shaped contact includes arc contact portions at two ends and a connecting portion connected between the two contact portions, the connecting portion is roughly flat, elastic deformation always occur at the transitional positions between the contact portions and the connecting portion when the C-shaped contact is used, the deformed parts are few, and the deformation range is small, so that the problem of fatigue damage is easily produced; the structure of the V-shaped contact is shown in FIG. 2, similarly, the contact portions are at two ends, and when the V-shaped contact is used, the deformed parts are more concentrated and the deformation range is smaller than that of the C-shaped contact, so that the V-shaped contact is more easily damaged by fatigue; the spiral contact, which does not adopt the plate-type structures of said C-shaped and V-shaped contacts, has relatively long service life but extremely high requirement for materials, the common copper material often cannot provide sufficient elastic contact force, and the circuit inductance of the spiral contact is relatively high and thus is unbeneficial to high-quality transmission of signals.

It can be known from the above description that the spring-type contact is easily damaged by fatigue, and although solving the problem that the spring-type contact is easily fatigable, the spiral contact has too harsh requirement for the material and the manufacturing cost is too high.

### SUMMARY OF THE INVENTION

The present invention is aimed at providing an M-like elastic contact spring for solving the problem that a spring-type contact is easily damaged by fatigue.

Simultaneously, the present invention is further aimed at providing a terminated adaptor connector using the M-like elastic contact spring.

To solve the above problem, the M-like elastic contact spring of the present invention adopts the following technical solution: the M-like elastic contact spring includes two contact portions at two ends and a connecting portion connected between the two contact portions, the contact portions are arc-shaped, the connecting portion is U-shaped, the contact portions are in are transitional connection with the connecting portion, and the connecting portion and the contact portions form an M structure together.

Two ends of the connecting portion are gradually close to each other.

The outer lateral surfaces at the transitional parts, formed by U-shaped vertical walls of the connecting portion and bottom of the connecting portion, form supporting surfaces for supporting the ends of the contact portions.

Deformation yielding clearances are formed between the ends of the contact portions and the corresponding supporting surfaces.

The terminated adaptor connector of the present invention adopts the following technical solution: the terminated adaptor connector includes a panel shell, the panel shell is provided with a penetrating mounting hole, a spring-type contact is arranged in the mounting hole, the contact includes two contact portions at two ends and a connecting portion connected between the two contact portions, the contact portions are arc-shaped, the connecting portion is U-shaped, the contact portions are in arc transitional connection with the connecting portion, and the connecting portion and the contact portions form an M structure together.

Two ends of the connecting portion of the contact are gradually close to each other.

The outer lateral surfaces at the transitional parts, formed by U-shaped vertical walls of the connecting portion of the contact and bottom of the connecting portion of the contact, form supporting surfaces for supporting the ends of the contact portions.

Deformation yielding clearances are formed between the ends of the contact portions of the contact and the corresponding supporting surfaces of the contact.

The connecting portion of the M-like elastic contact spring of the present invention is U-shaped, the contact portions are in arc transitional connection with the connecting portion, the connecting portion and the contact portions form an M structure together, and when the contact portions are in contact with the adaptor connector and stressed during usage, the M-like elastic contact spring shall at least have the following deformable parts: a U-shaped bent part of the connecting portion, transitional parts of the two contact portions and the connecting portion, and the parts, close to the connecting portion, of the contact portions; thus, the bending stress of the contact spring under stress can be greatly dispersed, and the fatigue of the contact spring is relieved. Thus it can be seen, the M-like elastic contact spring of the present invention solves the problem that the spring-type contact is easily damaged by fatigue.

Further, the two ends of the connecting portion are gradually close to each other in order to guide the deformed positions when the contact spring is stressed, thereby ensuring that the contact spring can bend according to the set position and range; and the supporting surfaces are formed for limiting the deformation amplitude of the contact spring to avoid fatigue of the contact spring due to excessive deformation.

### BRIEF DESCRIPTION OF THE DRAWINGS

FIG. 1 is a structural schematic diagram of a C-shaped contact;

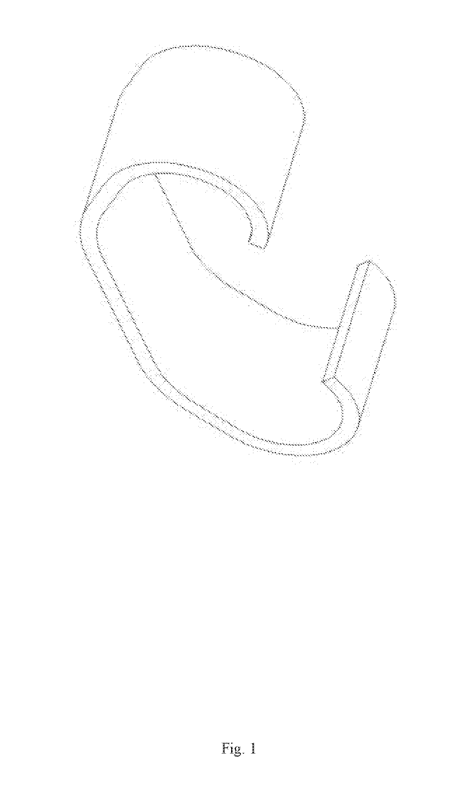

FIG. 2 is a structural schematic diagram of a V-shaped contact;

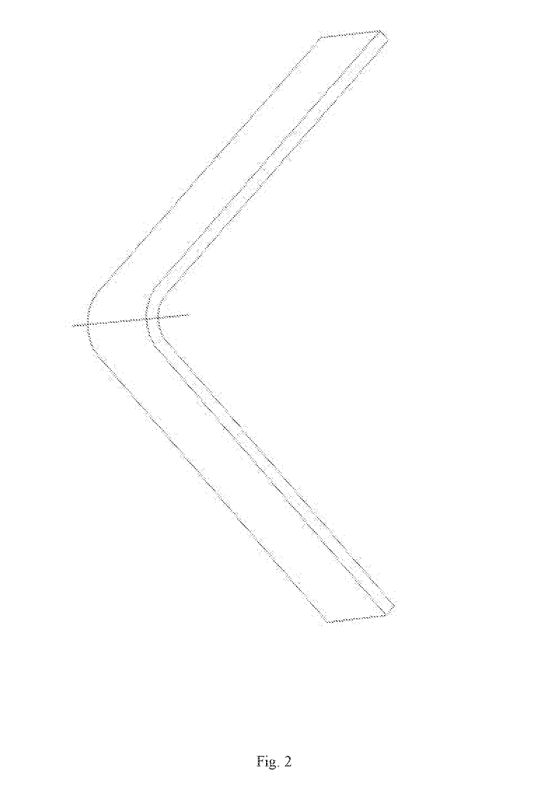

FIG. 3 is a structural schematic diagram of a spiral contact;

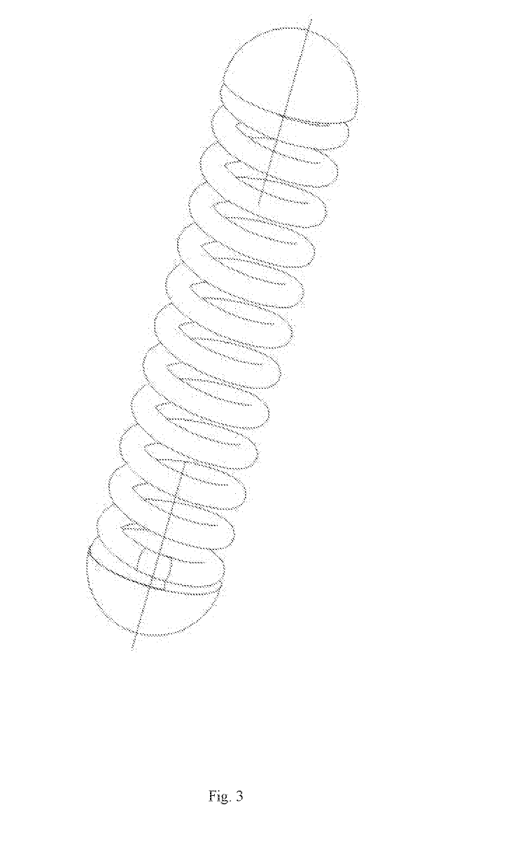

FIG. 4 is a structural schematic diagram of an embodiment of an M-like elastic contact spring;

FIG. 5 is a using state diagram of an embodiment of an M-like elastic contact spring;

FIG. 6 is a sectional view of an embodiment of an M-like elastic contact spring in a using state.

### DETAILED DESCRIPTION OF THE EMBODIMENTS

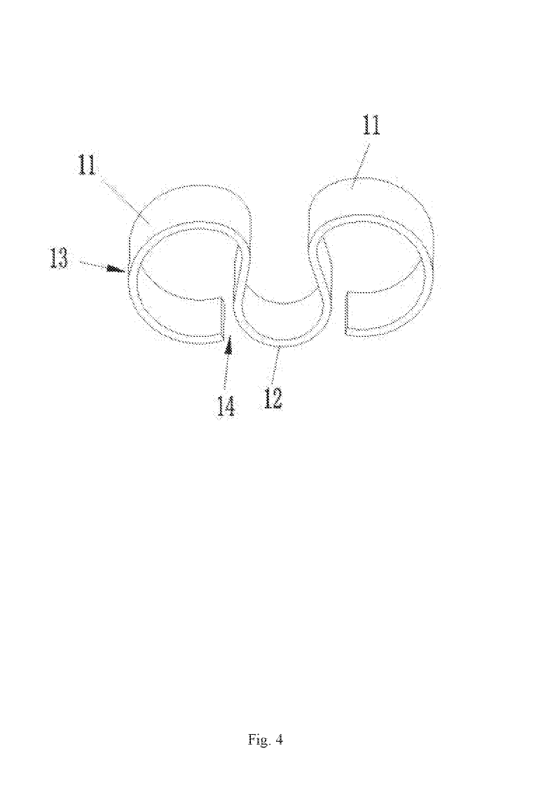

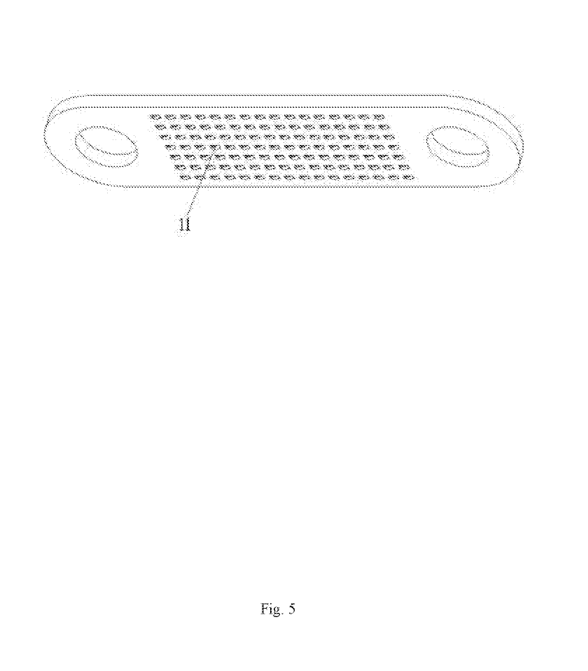

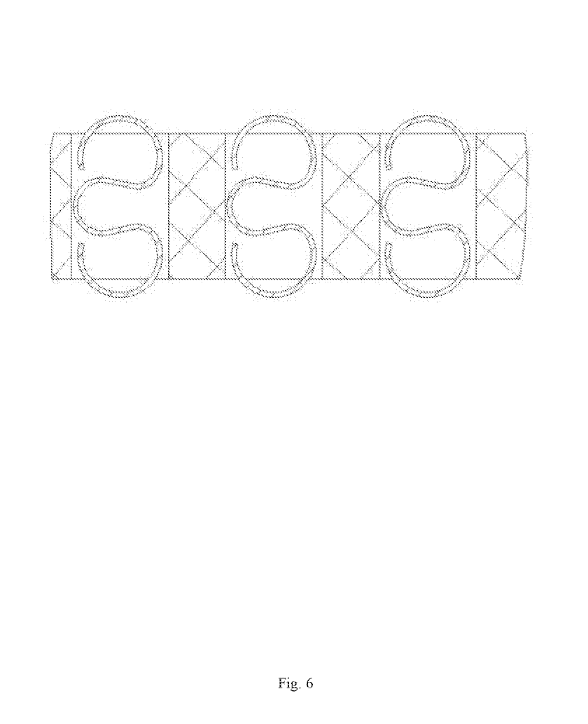

An embodiment of an M-like elastic contact spring is shown in FIGS. 4-6, and the M-like elastic contact spring includes two contact portions 11 at two ends and a connecting portion 12 connected between the two contact portions 11.

The contact portions 11 are arc-shaped, in this embodiment, the contact portions 11 are specifically in a circular arc shape and the outer lateral surfaces of the arc tops of the contact portions 11 can be used as contact surfaces in contact with an adaptor connector during usage.

The connecting portion 12 is U-shaped, in this embodiment, the U shape of the connecting portion 12 is not standard U shape, specifically, two ends of the connecting portion 12 are gradually close to each other, a U shape having a closing trend is actually formed, and such design is to guide the bending positions of the connecting portion 12 when the two ends are stressed and to enlarge the bending range thereof, because extremely gentle bending structures are actually formed at the tilting starting positions when the two ends of the connecting portion 12 are gradually tilted and close. The contact portions 11 are in arc transitional connection with the connecting portion, and the connecting portion and the contact portions form an M structure together. In this embodiment, the ends of the contact portions 11 extend to the positions almost approaching the bottom of the connecting portion 12, in this case, when the contact portions 11 are stressed and the whole contact spring is deformed, the ends of the contact portions 11 press against the outer lateral surfaces at the transitional parts, formed by U-shaped vertical walls of the connecting portion and bottom of the connecting portion, thereby limiting the deformation quantity of the contact spring and preventing excessive deformation of the contact spring; thus, the outer lateral surfaces at the transitional parts, formed by the U-shaped vertical walls of the connecting portion and the bottom of the connecting portion, form supporting surfaces 13 for supporting the ends of the contact portions, and deformation yielding clearances 14 are formed between the ends of the contact portions and the corresponding supporting surfaces.

In other embodiments of the M-like elastic contact spring, the connecting portion may also be C-shaped or standard U-shaped, the contact portions may also be in an elliptic arc shape, and all in all, the whole connecting portion and contact portions can disperse the deformation stress of the contact spring under stress.

In an embodiment of a terminated adaptor connector, the terminated adaptor connector includes a panel shell and a contact, wherein the structure of the panel shell is the prior art and thus is not redundantly described herein. The structure of the contact is same as that of said M-like elastic contact spring, and thus is not redundantly described herein.

1. An M-like elastic contact spring, comprising two contact portions at two ends and a connecting portion connected between the two contact portions, the contact portions are arc-shaped, wherein the connecting portion is U-shaped, the contact portions are in arc transitional connection with the connecting portion, and the connecting portion and the contact portions form an M structure together.

2. The M-like elastic contact spring as set forth in claim 1, wherein two ends of the connecting portion are gradually close to each other.

3. The M-like elastic contact spring as set forth in claim 1, wherein outer lateral surfaces at the transitional parts, formed by U-shaped vertical walls of the connecting portion and bottom of the connecting portion, form supporting surfaces for supporting the ends of the contact portions.

4. The M-like elastic contact spring as set forth in claim 3, wherein deformation yielding clearances are formed between the ends of the contact portions and the corresponding supporting surfaces.

5. A terminated adaptor connector, comprising a panel shell, the panel shell is provided with a penetrating mounting hole, a spring-type contact is arranged in the mounting hole, the contact comprises two contact portions at two ends and a connecting portion connected between the two contact portions, the contact portions are arc-shaped, wherein the connecting portion is U-shaped, the contact portions are in arc transitional connection with the connecting portion, and the connecting portion and the contact portions form an M structure together.

6. The terminated adaptor connector as set forth in claim 5, wherein two ends of the connecting portion of the contact are gradually close to each other.

7. The terminated adaptor connector as set forth in claim 5, wherein outer lateral surfaces at the transitional parts, formed by U-shaped vertical walls of the connecting portion of the contact and bottom of the connecting portion of the contact, form supporting surfaces for supporting the ends of the contact portions.

8. The terminated adaptor connector as set forth in claim 7, wherein deformation yielding clearances are formed between the ends of the contact portions of the contact and the corresponding supporting surfaces.

9. The M-like elastic contact spring as set forth in claim 2, wherein the outer lateral surfaces at the transitional parts, formed by the U-shaped vertical walls of the connecting portion and the bottom of the connecting portion, form the supporting surfaces for supporting the ends of the contact portions.

10. The M-like elastic contact spring as set forth in claim 9, wherein deformation yielding clearances are formed between the ends of the contact portions and the corresponding supporting surfaces.

11. The terminated adaptor connector as set forth in claim 6, wherein the outer lateral surfaces at the transitional parts, formed by the U-shaped vertical walls of the connecting portion of the contact and the bottom of the connecting portion of the contact, form the supporting surfaces for supporting the ends of the contact portions.

12. The terminated adaptor connector as set forth in claim 11, wherein the deformation yielding clearances are formed between the ends of the contact portions of the contact and the corresponding supporting surfaces.
